(19) United States
(12) Patent Application Publication
(10) Pub. No.: US 2022/0234056 A1
(43) Pub. Date: Jul. 28, 2022

(54) INLET ASSEMBLY FOR AN ABATEMENT APPARATUS

(71) Applicant: Edwards Limited, Burgess Hill,West Sussex (GB)

(72) Inventors: Andrew James Seeley, Burgess Hill, Sussex (GB); Ian David Stones, Burgess Hill, Sussex (GB); Duncan Michael Price, Burgess Hill, Sussex (GB)

(21) Appl. No.: 17/617,473

(22) PCT Filed: Jun. 5, 2020
(86) PCT No.: PCT/EP2020/065647

§ 371 Date: Dec. 8, 2021

(30) Foreign Application Priority Data
Jun. 10, 2019 (GB) 1908276.7

(51) Int. Cl. B05B 1/14; F23G 7/06

(52) U.S. Cl. CPC B05B 1/14; B05B 1/24; F23G 7/061

(57) ABSTRACT

An inlet assembly for an abatement apparatus includes an inlet nozzle defining a non-circular inlet aperture coupleable with an inlet conduit providing an effluent gas stream for treatment by the abatement apparatus, at least one outlet aperture and a nozzle bore extending along a longitudinal axis between the non-circular inlet aperture and the outlet aperture for conveying the effluent gas stream from the non-circular inlet aperture to the outlet aperture for delivery to a treatment chamber of the abatement apparatus, the nozzle bore defining an inlet portion extending from the non-circular inlet aperture, a flow-dividing structure positioned downstream of the inlet portion and configured to separate the effluent gas stream into at least a pair of effluent gas streams and an outlet portion extending to the outlet aperture and configured to convey the pair of effluent gas streams to the treatment chamber of the abatement apparatus.

### CROSS-REFERENCE OF RELATED APPLICATION

This application is a Section 371 National Stage Application of International Application No. PCT/EP2020/065647, filed Jun. 5, 2020, and published as WO 2020/249482 A1 on Dec. 17, 2020, the content of which is hereby incorporated by reference in its entirety and which claims priority of British Application No. 1908276.7, filed Jun. 10, 2019.

### FIELD

The present invention relates to an inlet assembly for an abatement apparatus and a method.

### BACKGROUND

Abatement apparatus, such as plasma abatement apparatus, electrical abatement apparatus and radiant burners are known and are typically used for treating an effluent gas stream from a manufacturing process tool used in, for example, the semiconductor or flat panel display manufacturing industry. During such manufacturing, residual perfluorinated compounds (PFCs) and other compounds exist in the effluent gas stream pumped from the process tool. PFCs are difficult to remove from the effluent gas and their release into the environment is undesirable because they are known to have relatively high greenhouse activity.

Known radiant burners use combustion to remove the PFCs and other compounds from the effluent gas stream. Typically, the effluent gas stream is a nitrogen stream containing PFCs and other compounds. A fuel gas is mixed with the effluent gas stream and that gas stream mixture is conveyed into a combustion chamber that is laterally surrounded by the exit surface of a foraminous gas burner. Fuel gas and air are simultaneously supplied to the foraminous burner to affect flameless combustion at the exit surface, with the amount of air passing through the foraminous burner being sufficient to consume not only the fuel gas supplied to the burner, but also all the combustibles in the gas stream mixture injected into the combustion chamber. Similar techniques are used in plasma abatement apparatus and electrical abatement apparatus.

The range of compounds present in the effluent gas stream and the flow characteristics of that effluent gas stream can vary from process tool to process tool, and so the range of fuel gas and air, together with other gases or fluids that need to be introduced into the radiant burner will also vary.

Although techniques exist for processing the effluent gas stream, they each have their own shortcomings. Accordingly, it is desired to provide an improved technique for processing an effluent gas stream.

The discussion above is merely provided for general background information and is not intended to be used as an aid in determining the scope of the claimed subject matter. The claimed subject matter is not limited to implementations that solve any or all disadvantages noted in the background.

### SUMMARY

According to a first aspect, there is provided an inlet assembly for an abatement apparatus, the inlet assembly comprising: an inlet nozzle defining a non-circular inlet aperture coupleable with an inlet conduit providing an effluent gas stream for treatment by the an abatement apparatus, at least one outlet aperture and a nozzle bore extending along a longitudinal axis between the non-circular inlet aperture and the outlet aperture for conveying the effluent gas stream from the non-circular inlet aperture to the outlet aperture for delivery to a treatment chamber of the abatement apparatus, the nozzle bore defining an inlet portion extending from the non-circular inlet aperture, a flow-dividing structure positioned downstream of the inlet portion and configured to separate the effluent gas stream into at least a pair of effluent gas streams and an outlet portion extending to the outlet aperture and configured to convey the pair of effluent gas streams to the treatment chamber of the an abatement apparatus.

The first aspect recognises that the shape and configuration of the inlet nozzles in the inlet assembly of an abatement apparatus can have a significant impact on the performance of that abatement apparatus. Although existing nozzles can have adequate performance, particularly at higher flow rates, their performance can reduce, particularly at lower flow rates. Accordingly, an abatement apparatus inlet assembly is provided. The inlet assembly may comprise an inlet nozzle or conduit. The inlet nozzle may have an other than circular inlet aperture which may couple with a conduit or hose which provides an effluent gas stream to be treated by the abatement apparatus. The inlet also may also have one or more outlet apertures which may deliver the effluent stream to a treatment chamber of the abatement apparatus. The inlet nozzle may comprise one or more nozzle bores which extend along the length of the inlet nozzle from the inlet aperture to the one or more outlet apertures. The nozzle bore may have an inlet portion or region extending from or adjacent to the inlet aperture. The nozzle bore may have a flow-dividing, flow-separating or weir structure located downstream or adjacent to the inlet portion. The flow-dividing structure may separate, partition or divide the effluent gas stream into more than one effluent gas streams. The nozzle bore may also have an outlet portion which extends between the flow-dividing structure and the outlet aperture and which conveys the effluent streams to the outlet apertures for treatment of the effluent gas stream in the treatment chamber of the abatement apparatus. In this way, multiple effluent gas streams are generated or produced by the inlet assembly which helps to improve the performance of the abatement apparatus, particularly at low flow rates. This is because the effluent treatment mechanism typically relies on a diffusion process within the radiant burner; the combustion bi-products need to diffuse into the effluent stream in order to perform the abatement reaction. In other words, the combustion by-products need to diffuse from an outer surface of the effluent stream, all the way into the effluent stream, and then react with the effluent stream, before the effluent stream exits the radiant burner. Failure to completely diffuse into the effluent stream reduces this abatement efficacy. By generating multiple, separate effluent streams from the effluent stream entering the nozzle provides a reduced distance along which diffusion reaction needs to occur compared to that of an equivalent single effluent gas stream. Also, the multiple effluent streams can be generated by the inlet nozzles even at low flow rates.

In one embodiment, the flow-dividing structure is configured to separate the effluent gas stream into the pair of effluent gas streams flowing either side of the flow-dividing structure. Accordingly, the flow-dividing structure may produce effluent gas streams through the intervention of the flow-dividing structure. The presence of the flow-dividing structure separates the effluent gas streams in order to reduce re-mixing and minimize the size of each effluent gas stream.

In one embodiment, the flow-dividing structure is centrally located within the nozzle bore. Locating the flow-dividing structure centrally can help to provide asymmetric and uniform flow into the treatment chamber and maximize the separation of the effluent gas streams.

In one embodiment, the flow-dividing structure is configured to separate the effluent gas stream into the pair of effluent gas streams flowing proximate a surface of the nozzle bore. Generating the effluent gas streams near to the surface of the nozzle bore also helps to separate the effluent gas streams.

In one embodiment, the inlet nozzle defines a single nozzle bore extending from the non-circular inlet aperture to the outlet aperture with the flow-dividing structure located therein. Accordingly, the inlet nozzle may be provided with a single, sole or unitary nozzle bore which houses the flow-dividing structure.

In one embodiment, the flow-dividing structure is configured to divide the nozzle bore into a pair of nozzle bores. Accordingly, the flow-dividing structure may separate the nozzle bore into two or more downstream nozzle bores.

In one embodiment, the inlet nozzle defines a single nozzle bore extending from the non-circular inlet aperture to the flow-dividing structure and the pair of nozzle bores extending from the flow-dividing structure to a pair of the outlet apertures. Accordingly, the inlet nozzle may have a single bore at its inlet, extending to the flow-dividing structure, but then have a pair of nozzle bores extending from the flow-dividing structure to a corresponding two or more outlet apertures.

In one embodiment, the inlet nozzle defines a lofted transition from the single nozzle bore to the pair of nozzle bores via the flow-dividing structure. Accordingly, a smooth transition may occur between the single nozzle bore and the pair of nozzle bores.

In one embodiment, the inlet nozzle has a longitudinal length extending in a major direction of flow of the effluent stream and the flow-dividing structure reduces a cross-sectional area of the nozzle bore along the longitudinal axis. Accordingly, the presence of the flow-dividing structure may cause a reduction, decrease or restriction in the cross-sectional area of the nozzle, which increases the flow of the effluent stream.

In one embodiment, the flow-dividing structure is positioned no closer to the non-circular inlet aperture than around 20% of the longitudinal length.

In one embodiment, the flow-dividing structure is shaped to present a surface orientated with a transverse component with respect to the longitudinal axis. Accordingly, the flow-dividing structure may have a portion which extends across a portion of the width of the nozzle bore.

In one embodiment, the surface is orientated by between around 20° to 70° with respect to the longitudinal axis. Accordingly, the surface may be orientated to achieve the required flow characteristics of the effluent stream.

In one embodiment, the surface is at least one of planar and curved. Accordingly, the surface may be shaped to achieve the required flow characteristics of the effluent stream.

In one embodiment, the flow-dividing structure is shaped to present a pair of the surfaces mirrored about at least one of the longitudinal axis and a major and a minor axis of the nozzle bore extending transverse to the longitudinal axis. Accordingly, the flow-dividing structure may be symmetric about a central axis of the inlet nozzle.

In one embodiment, the non-circular inlet aperture is elongate and/or a generally quadrilateral slot and/or an obround.

In one embodiment, the inlet assembly comprises a baffle positioned upstream of the flow-dividing structure, the baffle defining a baffle aperture, the baffle aperture having a reduced cross-sectional area compared to that of the nozzle bore adjacent the baffle.

According to a second aspect, there is provided a method, comprising: receiving an effluent stream at an inlet assembly for an abatement apparatus, the inlet assembly comprising an inlet nozzle defining a non-circular inlet aperture coupleable with an inlet conduit providing the effluent gas stream for treatment by the abatement apparatus, at least one outlet aperture and a nozzle bore extending along a longitudinal axis between the non-circular inlet aperture and the outlet aperture, the nozzle bore defining an inlet portion extending from the non-circular inlet aperture, a flow-dividing structure positioned downstream of the inlet portion, and an outlet portion extending to the outlet aperture; conveying the effluent gas stream from the non-circular inlet aperture to the flow-dividing structure; separating the effluent gas stream into at least a pair of effluent gas streams with the flow-dividing structure and conveying the pair of effluent gas streams to the at least one outlet aperture for delivery to a treatment chamber of the abatement apparatus.

In embodiments of the second aspect, there are provided features corresponding to embodiments of the first aspect.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIGS. 1 and 2 illustrate a head assembly according to one embodiment coupled with a radiant burner assembly;

FIG. 3 is a cross-sectional view through an inlet nozzle according to one embodiment;

FIG. 4 is a cross-sectional view through an inlet nozzle according to one embodiment;

FIGS. 5A and 5B illustrate an inlet nozzle according to one embodiment; and

FIG. 6 illustrates a baffle plate positioned upstream the inlet nozzle.

### DETAILED DESCRIPTION

Before discussing the embodiments in any more detail, first an overview will be provided. Embodiments provide a burner inlet assembly. The burner inlet assembly comprises a dividing structure or weir which separates the received effluent gas stream into multiple separate effluent gas streams for delivery into the treatment chamber of an abatement apparatus. The presence of the flow separator helps to maintain separate effluent streams, even at low flow rates. This reduces the distance along which diffusion reaction needs to occur, compared to that of an equivalent single effluent gas stream, which improves the abatement performance, particularly at low flow rates.

Although the following embodiments describe the use of radiant burners, it will be appreciated that the inlet assembly may be used with any of a number of different burners such as, for example, turbulent flame burners or electrically heated oxidisers. Radiant burners are well known in the art, such as that described in EP 0 694 735.

### Head Assembly

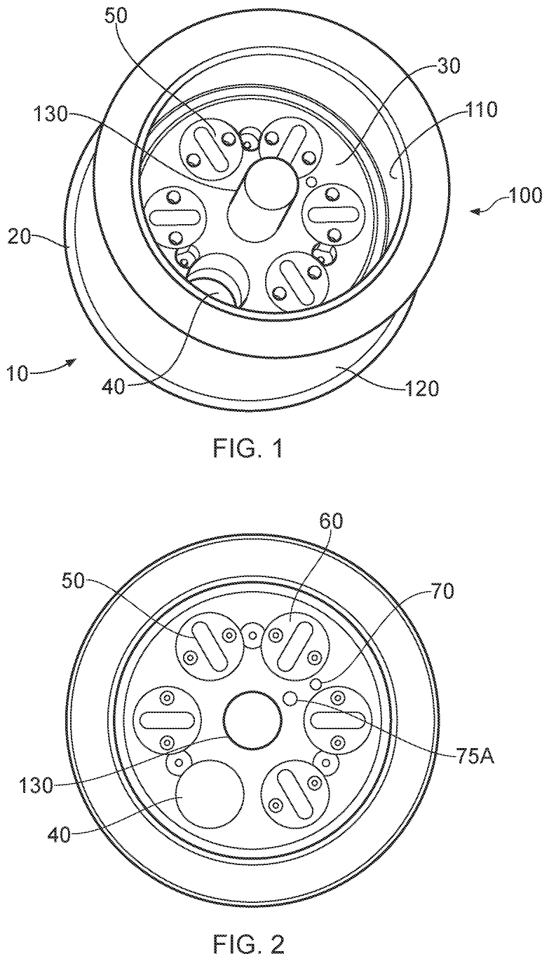

FIGS. 1 and 2 illustrate a head assembly, generally 10, according to one embodiment coupled with a radiant burner assembly 100. In this example, the radiant burner assembly 100 is a concentric burner having an inner burner 130 and an outer burner 110 (although other arrangements are possible). A mixture of fuel and oxidant is supplied via a plenum (not shown) within a plenum housing 120 to the outer burner 110 and a conduit (not shown) to the inner burner 130.

The head assembly 10 comprises three main sets of components. The first is a metallic (typically stainless steel) housing 20, which provides the necessary mechanical strength and configuration for coupling with the radiant burner assembly 100. The second is an insulator 30 which is provided within the housing 20 and which helps to reduce heat loss from within a combustion chamber defined between the inner burner 130 and the outer burner 110 of the radiant burner assembly 100, as well as to protect the housing 20 and items coupled thereto from the heat generated within the combustion chamber. The third are inlet assemblies 60 which receive a nozzle in a void 50 and are received by a series of identical, standardized apertures 40 (see FIG. 2) provided in the housing 20. This arrangement enables individual inlet assemblies 60 to be removed for maintenance, without needing to remove or dissemble the complete head assembly 10 from the remainder of the radiant burner assembly 100.

The embodiment shown in FIG. 1 utilises five identical inlet assemblies 60, each mounted within a corresponding aperture 40, the sixth aperture is shown vacant. It will be appreciated that not every aperture 40 may be filled with an inlet assembly 60 which receives an effluent or process fluid, or other fluid via its nozzle, and may instead receive a blanking inlet assembly to completely fill the aperture 40, or may instead receive an instrumentation inlet assembly housing sensors in order to monitor the conditions within the radiant burner. Also, it will be appreciated that greater or fewer than six apertures 40 may be provided, that these need not be located circumferentially around the housing, and that they need not be located symmetrically either.

As can also be seen in FIGS. 1 and 2, additional apertures are provided in the housing 20 in order to provide for other items such as, for example, a sight glass 70 and a pilot 75A.

The inlet assemblies 60 are provided with an insulator to protect the structure of the inlet assemblies 60 from the combustion chamber. The inlet assemblies 60 are retained using suitable fixings such as, for example, bolts (not shown) which are removed in order to facilitate their removal and these are also protected with an insulator (not shown). The nozzles have one or more outlet aperture and a baffle portion as will be explained in more detail below.

### Inlet Nozzle—1^{st} Embodiment

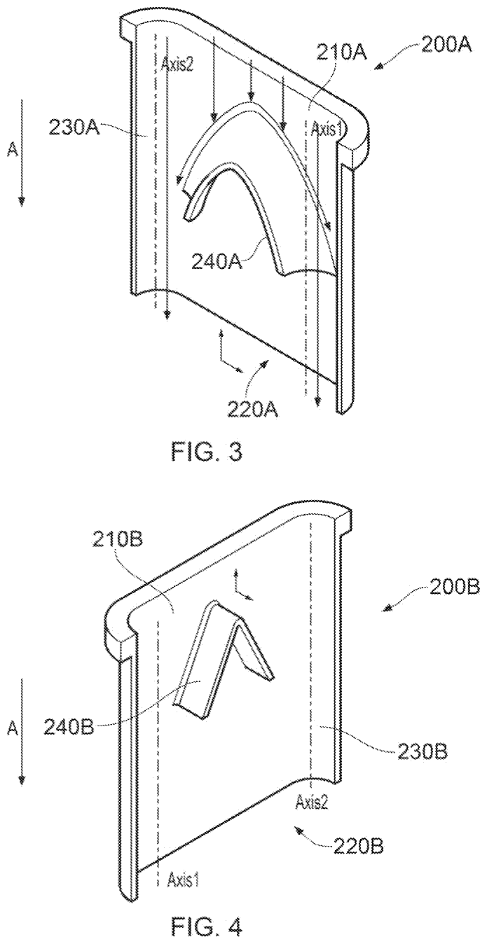

FIG. 3 is a cross-sectional view through an inlet nozzle 200A according to one embodiment. The inlet nozzle 200A is mirrored about the cross-sectional view shown in FIG. 3. The inlet nozzles 200A fit into the voids 50, which are typically shaped to fit its external surface. The inlet nozzle 200A comprises an inlet aperture 210A, an outlet aperture 220A and a nozzle bore 230A extending along a longitudinal axis A between the inlet aperture 210A and the outlet aperture 220A. In this example, the nozzle bore 230A has an obround cross section. The obround comprises two semicircles connected by parallel lines tangential to their endpoints. Accordingly, the inlet nozzle forms a flattened tube having parallel major faces and hemi-cylindrical joining faces. The outer wall defining the nozzle bore 230A has a uniform cross-section along the longitudinal axis A.

Within the nozzle bore 230A is provided a flow divider 240A. The flow divider 240A extends from and between the two internal major faces of the nozzle bore 230A. In particular, the flow divider 240A presents a curved surface upstanding from the major surfaces of the nozzle bore 230A and are shaped to split the flow of the effluent stream traveling generally along the longitudinal axis A, creating two streams flowing in the vicinity of the rounded portions of the nozzle bore 230A. The curved surface of the flow divider 240A extends from a central location towards the curved portions of the nozzle bore 230A, forming an arch-shaped structure shown in cross-section in FIG. 3, whose leading surface is formed as a generally cylindrical recess.

In operation, the effluent stream is introduced through the inlet aperture 210A and travels generally in the direction of the longitudinal axis A. The effluent stream is split into two effluent streams, one passing on either side of the flow divider 240A and exiting the outlet aperture 220A generally as a pair of effluent streams.

### Inlet Nozzle—2^{nd} Embodiment

FIG. 4 is a cross-sectional view through an inlet nozzle 200B according to one embodiment. The inlet nozzle 200B is identical to the inlet nozzle described above but has a differently shaped flow divider 240B. The flow divider 240B extends from and between the two internal major faces of the nozzle bore 230B. In particular, the flow divider 240B is formed from a pair of planar surfaces upstanding from the major internal surfaces of the nozzle bore 230B and are shaped to split the flow of the effluent stream traveling generally along the longitudinal axis A, creating two streams flowing in the vicinity of the rounded portions of the nozzle bore 230B. The planar surfaces of the flow divider 240B extend from a central location towards the curved portions of the nozzle bore 230B, forming an inverted V-shaped structure shown in cross-section in FIG. 4, whose leading surface is formed as a pair of generally flat surfaces.

In operation, the effluent stream is introduced through the inlet aperture 210B and travels generally in the direction of the longitudinal axis A. The effluent stream is split into two effluent streams, one passing on either side of the flow divider 240B and exiting the outlet aperture 220B generally as a pair of effluent streams.

### Inlet Nozzle—3^{rd} Embodiment

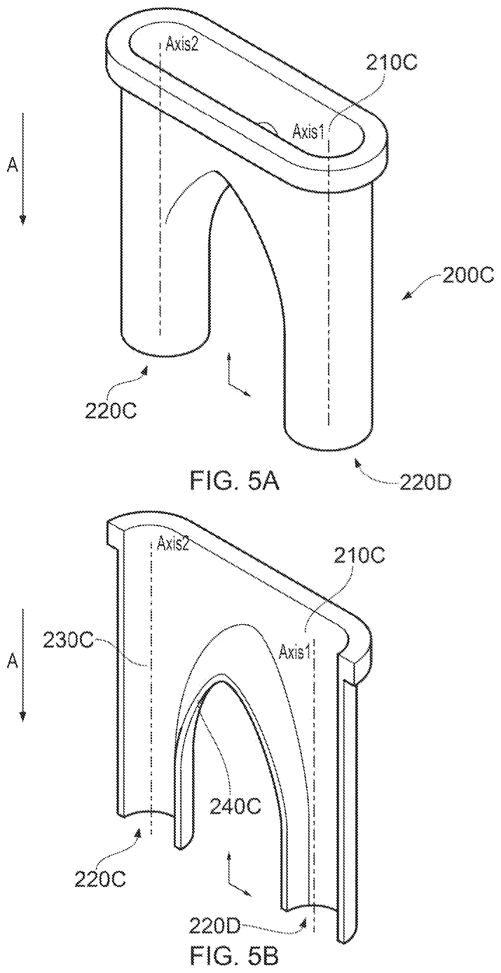

FIGS. 5A and 5B illustrate an inlet nozzle 200C according to one embodiment. This embodiment is identical to that of FIG. 3 with the exception that the flow divider 240C is extended in the direction of the longitudinal axis A to the position of the outlet apertures 220C, 220D and that portion of the major surface of the nozzle bore 230C which is redundant has been removed. In this embodiment, therefore, the inlet nozzle 200C has one inlet aperture 210C and two outlet apertures 220C, 220D.

In operation, the effluent stream is introduced through the inlet aperture 210C and travels generally in the direction of the longitudinal axis A. The effluent stream is split into two effluent streams, one passing on either side of the flow divider 240C and exiting the two outlet aperture 220C, 220D as a pair of effluent streams.

It will be appreciated that the position of the flow dividers 240A, 240B, 240C may be varied to suit flow conditions. Should the flow of the effluent stream entering the inlet aperture 210, 210A, 210B, not be uniform or be un-symmetric, the position of the flow dividers 240A, 240B, 240C may be adjusted in the axis transverse to the longitudinal axis A to generate a pair of symmetric effluent gas streams. Also, the position of the flow dividers 240A, 240B, 240C may be varied to alter the distance from the inlet aperture 210A, 210B, 210C to avoid any areas of high turbulence. Also, it will be appreciated that the shape and angle of attack of the pair of surfaces of the flow dividers 240A, 240B, 240C can be varied to suit flow conditions.

### Baffle Plate

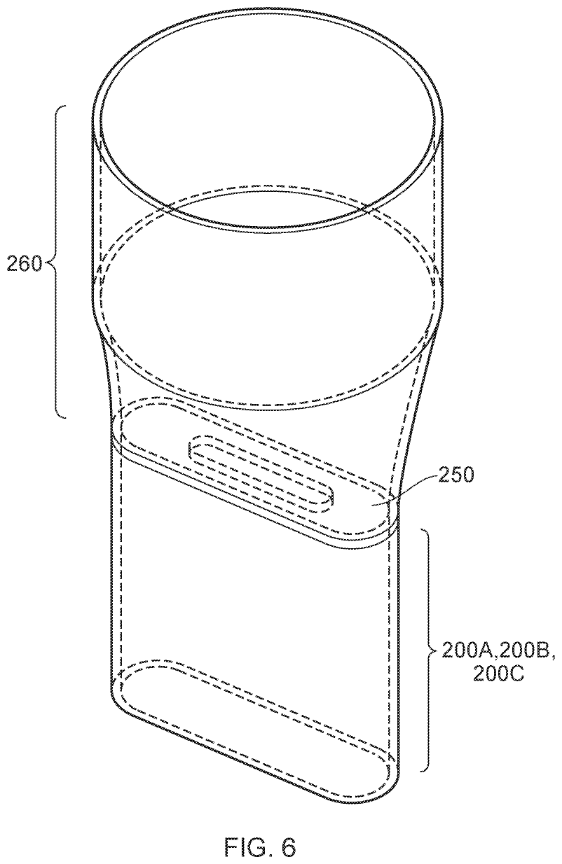

In embodiments, a baffle plate 250 is positioned upstream of the flow-dividing structure 240, 240A, 240B, as illustrated in FIG. 6. The baffle plate 250 may be provided within the nozzle bore 230A, 230B, 230, on the inlet aperture 210A, 210B, 210C or (as illustrated) in a coupling 260 which couples with the inlet nozzle 200A, 200B, 200C.

Accordingly, it can be seen that embodiments provide a sub-divided slot nozzle. This arrangement enhances performance over existing nozzles at low flow rates. In particular, although some existing nozzles can provide for good abatement performance, particularly at higher flow rates, embodiments extend that performance to lower flow rates.

Typically, in embodiments, the nozzle is constructed from a heat and chemically resistant metal alloy, for example ANC16. The nozzle is conveniently formed by a casting process, for example lost wax casting. The inlet to the nozzle is in the form of an obround aperture being 16 mm internal width on 50 mm centres. This form typically continues parallel for approximately 25% of the total length. Thereafter, a weir or flow-divider is formed in the central portions to urge the flow to adopt two separate streams. In one embodiment, the weir is such that the nozzle has two separate outlets. These outlets may be circular. They may be on the same centres as the obround inlet. In other embodiments, the weir extends to greater or lesser distances towards the discharge end of the nozzle which retains the same obround form as the inlet. The weir may be in the form of a chevron and may be flat sided or may be radiused.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. An inlet assembly for an abatement apparatus, said inlet assembly comprising:
an inlet nozzle defining
a non-circular inlet aperture coupleable with an inlet conduit providing an effluent gas stream for treatment by said an abatement apparatus,
at least one outlet aperture and
a nozzle bore extending along a longitudinal axis between said non-circular inlet aperture and said outlet aperture for conveying said effluent gas stream from said non-circular inlet aperture to said outlet aperture for delivery to a treatment chamber of said abatement apparatus, said nozzle bore defining
an inlet portion extending from said non-circular inlet aperture,
a flow-dividing structure positioned downstream of said inlet portion and configured to separate said effluent gas stream into at least a pair of effluent gas streams and
an outlet portion extending to said outlet aperture and configured to convey said pair of effluent gas streams to said treatment chamber of said an abatement apparatus.

2. The inlet assembly of claim 1, wherein said flow-dividing structure is configured to separate said effluent gas stream into said pair of effluent gas streams flowing either side of said flow-dividing structure.

3. The inlet assembly of claim 1, wherein said flow-dividing structure is centrally located within said nozzle bore.

4. The inlet assembly of claim 1, wherein said flow-dividing structure is configured to separate said effluent gas stream into said pair of effluent gas streams flowing proximate a surface of said nozzle bore.

5. The inlet assembly of claim 1, wherein said inlet nozzle defines said nozzle bore as a single nozzle bore extending from said non-circular inlet aperture to said outlet aperture with said flow-dividing structure located therein.

6. The inlet assembly of claim 1, wherein said flow-dividing structure is configured to divide said nozzle bore into a pair of nozzle bores.

7. The inlet assembly of claim 6, wherein said inlet nozzle defines a single nozzle bore extending from said non-circular inlet aperture to said flow-dividing structure and said pair of nozzle bores extending from said flow-dividing structure to a pair of said outlet apertures.

8. The inlet assembly of claim 6, wherein said inlet nozzle defines a lofted transition from said single nozzle bore to said pair of nozzle bores via said flow-dividing structure.

9. The inlet assembly of claim 1, wherein said inlet nozzle has a longitudinal length extending in a major direction of flow of said effluent stream and said flow-dividing structure reduces a cross-sectional area of said nozzle bore along said longitudinal axis.

10. The inlet assembly of claim 9, wherein said flow-dividing structure is positioned no closer to said non-circular inlet aperture than 20% of said longitudinal length.

11. The inlet assembly of claim 1, wherein said flow-dividing structure is shaped to present a surface orientated with a transverse component with respect to said longitudinal axis.

12. The inlet assembly of claim 11, wherein said surface is at least one of:
orientated by between 20° to 70° with respect to said longitudinal axis; and
at least one of planar and curved.

13. The inlet assembly of claim 11, wherein said flow-dividing structure is shaped to present a pair of said surfaces mirrored about at least one of said longitudinal axis and a major and a minor axis of said nozzle bore extending transverse to said longitudinal axis.

14. The inlet assembly of claim 1, comprising a baffle positioned upstream of said flow-dividing structure, said baffle defining a baffle aperture, said baffle aperture having a reduced cross-sectional area compared to that of said nozzle bore adjacent said baffle.

15. A method, comprising:
receiving an effluent stream at an inlet assembly for an abatement apparatus, the inlet assembly comprising an inlet nozzle defining a non-circular inlet aperture coupleable with an inlet conduit providing the effluent gas stream for treatment by the abatement apparatus, at least one outlet aperture and a nozzle bore extending along a longitudinal axis between the non-circular inlet aperture and the outlet aperture, the nozzle bore defining an inlet portion extending from the non-circular inlet aperture, a flow-dividing structure positioned downstream of the inlet portion, and an outlet portion extending to the outlet aperture;
conveying the effluent gas stream from the non-circular inlet aperture to the flow-dividing structure;
separating the effluent gas stream into at least a pair of effluent gas streams with the flow-dividing structure; and
conveying the pair of effluent gas streams to the at least one outlet aperture for delivery to a treatment chamber of the abatement apparatus.
